(19) United States
(12) Patent Application Publication
(10) Pub. No.: US 2017/0285597 A1
(43) Pub. Date: Oct. 5, 2017

(54) METHOD FOR CONTROLLING THE COOKING PROCESS IN OVENS FOR FOOD USE

(71) Applicant: UNOX S.p.A., CADONEGHE (PD) (IT)

(72) Inventor: Enrico FRANZOLIN, CADONEGHE (PD) (IT)

(73) Assignee: UNOX S.p.A., CADONEGHE (PD) (IT)

(21) Appl. No.: 15/471,624

(22) Filed: Mar. 28, 2017

(30) Foreign Application Priority Data
Apr. 5, 2016 (IT) 102016000034750

(51) Int. Cl. G05B 19/042; A23L 5/10; F27D 19/00; A47J 37/06

(52) U.S. Cl. CPC G05B 19/042; A47J 37/0629; A47J 37/0664; A23L 5/15; F27D 19/00; A23V 2002/00; G05B 2219/2643; F27D 2019/0003; F27D 2019/0093

(57) ABSTRACT

A method for controlling the cooking process in a cooking chamber of an oven is provided. The chamber includes at least one heating element, at least one fan having respective intake and delivery areas, and at least one baking tray. A temperature sensor is arranged in the delivery area, measuring the temperature of the air and/or steam which comes into contact with the food at the entry to the at least one baking tray, and compares that to the cooking temperature which is set in the corresponding cooking program. The method includes: providing a second temperature sensor in the intake area of the fan; calculating temperature difference detected by the sensors; setting a predetermined difference between the temperatures; and controlling the heating element and the fan during cooking to keep the temperature difference in the cooking chamber equal to or below the predetermined value throughout the actual cooking time.

### FIELD OF THE INVENTION

The present invention relates to a method for controlling the cooking process in ovens for food use.

The invention is particularly, but not exclusively, relevant to the technical field of methods for controlling the cooking processes in ovens for food use, where the cooking processes take place in convection ovens or combined (air and steam) ovens.

### BACKGROUND

One of the problems encountered in this field is that of providing the best possible uniformity of cooking. In these ovens, the concept of uniformity of cooking is related to various aspects concerned with the size of pieces of food to be cooked and their distribution in the cooking chamber. A certain number of baking trays containing food may be placed in an oven of this type, and a plurality of pieces of food for cooking may be placed in each baking tray. An example of this is seen in ovens for pastry products, in the baking of sweet pastries placed in a certain number on a plurality of baking trays housed simultaneously in the cooking chamber of the oven.

With reference to this example, assuming that the same type of food, characterized by the same shape, weight, composition (percentage of water, sugars, fats, protein, etc.), structure and surface appearance (also denoted by the term “texture”) is to be cooked, and if these pieces of food are placed in the same number and arrangement in each baking tray, two kinds of non-uniformity of cooking may occur.

A first kind of non-uniformity is the non-uniformity of cooking between one baking tray and another, and depends primarily on the geometry of the oven, the distribution of the air speeds in the vertical direction (from the lowest to the highest part of the cooking chamber), and the position and geometry of the heating elements. The problems of this kind of non-uniformity are not expressly tackled by the present invention.

However, a second type of non-uniformity concerns a specific baking tray placed at a specific point in the cooking chamber. In the following text, therefore, the expression “uniformity of cooking” of food is considered to relate to a specific baking tray placed at a specific level in the oven, and to a specific batch of food characterized by the same quality, shape, weight, composition and arrangement.

On this basis, the degree of uniformity of cooking is difficult to evaluate by objective methods, because it depends on the color, the surface structure (texture), and the organoleptic characteristics of each individual piece of food on the baking tray in question. Typically, after the definition of the food and a standard cooking program, the evaluation is carried out by a number of persons, on the basis of a sensory analysis or, more simply, the color and shape of the cooked food. This evaluation may be made more objective by awarding grades which may, for example, relate to an evaluation scale (providing an evaluation assessment from 1 to 10, for example).

In all cases, however, the non-uniformity of cooking among pieces of food on the same baking tray depends on:
a) the temperature of the surface and the interior of the food,
b) the speed (intensity and direction) of the air and/or steam coming into contact with the food,
c) and the temperature of the air and/or steam coming into contact with the food.

The temperature (surface and internal) of the food depends on its initial temperature and on conditions b) and c), and obviously varies over time.

The speed of the air and/or steam depends on the geometry of the oven, the type of fan, its rotation speed and the number and position of baking trays in the oven. Clearly, it also depends on the point on the baking tray that is examined, since the position and shape of the food on the baking tray have a substantial effect on the fluid dynamics at different points. In the following text, reference will always be made to a given fan or fan system (there may be a plurality of fans), a given geometry (of the cooking chamber, the baking tray supports, the casing, etc.) and a specified arrangement of the food on the baking tray, so that the only remaining variable is the number of baking trays. Evidently, if there is a change in the number of baking trays and their position in the oven, there is also a change in the fluid dynamics of the air and steam, and consequently in the speed affecting the food at individual points on the baking tray.

The temperature of the air and/or steam also depends greatly on the point on the baking tray that is examined. Indeed, if cooking takes place at a specified temperature (180° C., for example), it is necessary to consider where this temperature is measured, and kept as constant as possible, by the oven control system. In most cases, the temperature is measured near the wall of the cooking chamber, in a delivery area of the oven fan. Consequently, the air coming into contact with the food, which comes from outside the baking tray, is at a temperature practically equal to the specified temperature (also called the set point temperature, equal to 180° C. in this example). As the air enters the baking tray and exchanges heat with the food, it is cooled. It will be readily understood that the air leaving the baking tray near the intake area of the fan may be at a much lower temperature than the set point (as much as 20° C. lower, for example).

Usually, at the start of the cooking process, if the set point temperature (Tset) is kept constant, it is found that the temperature difference (DT) between the average temperature (Tin) of the air and/or steam entering the baking tray (typically from three sides, that is to say from the opposite lateral walls and from the front) and the mean temperature (Tout) at the exit from the baking tray (typically from the said nearest to the fan) is much greater than the temperature difference found at the end of cooking. This phenomenon causes the pieces of food positioned at the edges of the baking tray to be contacted by hotter air and/or steam than the pieces located in the center of the baking tray and/or near the fan intake, resulting in non-uniformity of cooking.

It should also be noted that, in most cases, ovens are pre-heated to a temperature higher than Tset so that, when the batch of food is placed in the oven, the resulting temperature decrease is not too great, enabling the oven to regain its temperature rapidly, thereby ensuring that the temperature of the air entering the baking tray (Tin) is practically equal to Tset. Thus the phenomenon described above, which leads to non-uniformity of cooking, is strengthened.

### SUMMARY

A principal object of the present invention is to provide a method for controlling the cooking process in ovens for food use, designed to overcome the drawbacks of the cited prior art, and intended, in particular, to reduce the non-uniformity of cooking.

This and other objects, which will be more fully apparent from the following text, are achieved by the invention by means of a method for controlling the cooking process, devised in accordance with the appended claims.

### BRIEF DESCRIPTION OF THE DRAWINGS

Other features and advantages of the invention will become clearer from the following detailed description of a preferred exemplary embodiment thereof, illustrated, for guidance and in a non-limiting way, with reference to the attached drawings, in which:

FIGS. 1 and 2 are schematic views, in side elevation and in plan view from above respectively, and in partial section, of a cooking oven designed for the implementation of the method for controlling the cooking process according to the present invention,

FIG. 3 is a view, corresponding to that of FIG. 2, relating to a step of the operation of the cooking process,

FIG. 4 shows in a Cartesian diagram the variation with time of the temperatures measured in the oven during the cooking process,

FIG. 5 is a schematic sectional view in side elevation of a detail of the oven,

FIG. 6 is a diagram corresponding to that of FIG. 4, showing the variation with time of the temperature difference between the temperatures measured in the oven during the cooking process, according to the method of the invention.

### DETAILED DESCRIPTION OF THE PREFERRED EMBODIMENTS

With reference to the aforementioned figures, the method according to the invention is designed to control the cooking process in an oven for food use, having a conventional structure, designed for cooking food according to a predetermined cooking program. The oven is designed to receive at least one baking tray in the cooking chamber, on which tray the food is arranged with a predetermined quality, quantity, piece size and distribution.

Cooking ovens suitable for the use of the method according to the invention may be convection (air) ovens or combined (air and steam) ovens, which can cook food in baking trays, the number of which may vary from 1 to n.

FIGS. 1 and 2 show schematically an oven of the aforesaid type, identified by the number 1, comprising a cooking chamber 2 which is accessed via a door 3. In the cooking chamber 2 there are provided one or more heating means, in the form of an electrical resistance 3a for example, and one or more fans 4 mounted in a rear wall 2a of the chamber (opposite the door 3). The fan 4 is rotated by a motor 5, and is separated from the cooking area of the oven by a casing 6. In the described configuration, the fan 4 has an axis of rotation X lying along a horizontal direction, that is to say parallel to a support surface of the oven on the ground, indicated by P in FIG. 1. A control unit 5a is provided in the oven to control the operation of the oven, particularly for the control of the heating means and the fan.

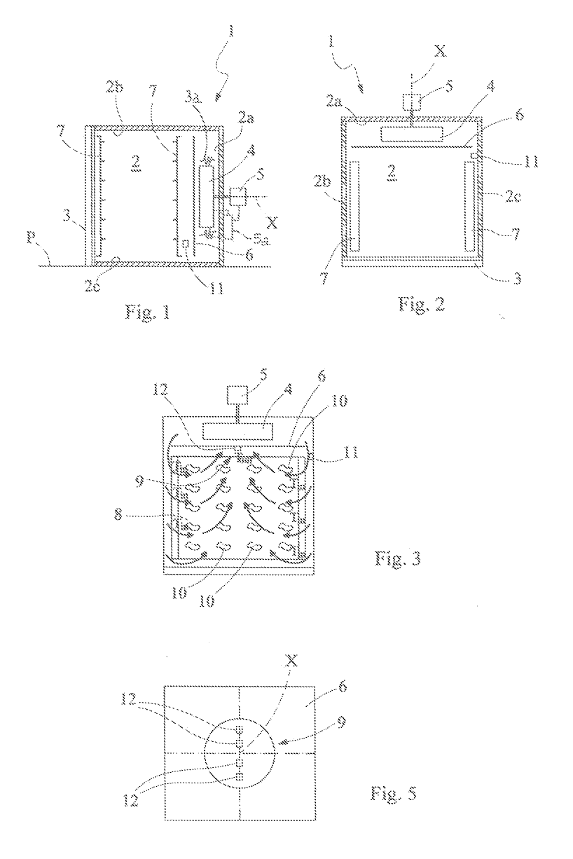

Supports 7 are provided inside the cooking area of the chamber 2, on each of the opposite lateral walls 2b, 2c of the chamber, and are designed to support a plurality of baking trays 8 to contain the food to be cooked. The baking trays 8 may be accommodated in the chamber by being stacked vertically one above the other, while being spaced apart. FIG. 3 shows schematically, in a top view, one of the baking trays 8, to which reference is made below for the description of the method according to the invention.

In the following text, it is assumed that the described method is applied with reference to a specific baking tray (tray 8 in the example), placed at a specific level in the oven, and to a specific batch of food characterized by the same quality, shape, weight, composition, piece size and arrangement. The number 10 indicates the pieces of food, shown schematically, arranged on the baking tray 8.

In the aforesaid conditions the invention aims to reduce as far as possible the degree of non-uniformity of cooking among the pieces of food 10 subjected to a predetermined cooking program.

According to the method, a first temperature sensor 11 is provided, and is placed inside the cooking chamber 2 in the delivery area of the fan 4 (being supported on one of the lateral walls 2b, 2c of the chamber, for example). Said sensor 11 is then provided to measure the temperature of the air (Tin) which comes into contact with the food from outside the baking tray 8, and which is then directed towards the intake area of the fan, as shown in FIG. 3 by the arrows which schematically indicate the lines along which the air flows relative to the baking tray.

Also, according to the method, at least a second temperature sensor, indicated by 12, is provided, this sensor being placed in the intake area (indicated by 9 in the drawings) of the fan, for example by fastening it to the casing 6, and being used to measure the temperature (Tout) of the air leaving the baking tray 8 near the intake area of the fan 4, after it has exchanged heat with the food placed in the baking tray.

For cooking the food, provision is made for the preliminary identification of a cooking program which can define the way in which the temperature value indicated by Tset (also called the set point temperature) is to vary with time. The symbol tset denotes the cooking time, that is to say the period of time between the initial instant (t=0) and the final instant (t=tset) at the end of cooking.

To simplify the description, the curve of variation of the temperature Tset (shown in solid lines and indicated by C in FIGS. 4 and 6) has a constant trend in the cooking interval tset, but other profiles of the curves C are obviously possible.

Assuming that the air coming from outside the baking tray 8 and striking the pieces of food 10 is at a temperature substantially equal to the specified set point (T=Tset), the air tends to be cooled as it enters the baking tray and exchanges heat with the food. Clearly, the air leaving the baking tray near the intake area of the fan is then at a much lower temperature than the temperature Tset. In most cases, at the start of the cooking process, if the set point (Tset) is kept constant, it is found that the temperature difference DT between the temperature Tin of the air and/or steam entering the baking tray (typically from three sides; see FIG. 3) and the temperature Tout of the air leaving the baking tray (from the side nearest to the fan; see FIG. 3) is much greater than the temperature difference DT at the end of cooking (see FIG. 4). This phenomenon causes the food positioned at the edges of the baking tray 8 to be contacted by hotter air and/or steam, by comparison with the food located in the center of the baking tray and/or near the fan intake, thus causing the cooking to be non-uniform.

The aim of the method according to the invention is to keep the temperature difference DT between suitable optimal values from the start to the end of cooking.

For this purpose, the method provides for the calculation of the difference DT between the values of the temperatures Tin and Tout measured by the sensors 11, 12, by subtracting the value of said temperature Tout at the intake from the temperature value Tin in the delivery area:

DT=Tin−Tout

On the basis of the calculated difference DT, the method provides for the setting of a predetermined difference DT′ between the temperatures which is less than the calculated temperature difference DT, but is such that it does not cause an increase in the cooking time tset beyond a predetermined percentage of the cooking time in order to complete the cooking process. Accordingly, the heating means and the fan 4 are controlled by the oven control unit during the cooking stage in such a way that the temperature difference in the cooking chamber is kept substantially constant and equal to the predetermined value DT′ during the cooking time tset.

In fact, the temperature difference DT cannot be reduced at will, since a decrease in this difference usually increases the cooking time; a condition of compromise (optimization) is therefore established, between a small difference DT (corresponding to high uniformity of cooking) and an acceptable cooking time. Tests conducted by the applicant have shown that, for a large number of foods, an increase in cooking time up to 100% may be readily accepted, if it is accompanied by a consistent increase in the uniformity of cooking.

As regards the identification of the temperature difference DT′ (DT′<DT), this difference is preferably selected to be within the range between DT−1° C. and DT=3° C., if DT−1° C.>1° C., or DT=2° C. for values of DT−1° C. less than or equal to 1° C., the temperature difference (DT) being calculated in the initial stages of the cooking process on the basis of the temperatures (Tin, Tout) measured by the respective sensors 11, 12 in the cooking chamber.

The correct measurement of the temperature Tout at the fan intake may prove to be rather difficult, since the temperature may be very different in different areas of the intake section, since at some points the air will have passed through the baking tray, thereby being considerably cooled and therefore showing a large difference DT, while at other points the air temperature will be only slightly below the temperature Tin, thus exhibiting a small difference DT. According to the invention, this problem is overcome by providing for the use of a plurality of temperature sensors in the intake area of the fan, and preferably by using the highest value of the calculated difference DT. If this choice is made, the phenomenon of non-uniformity of cooking can be controlled more effectively.

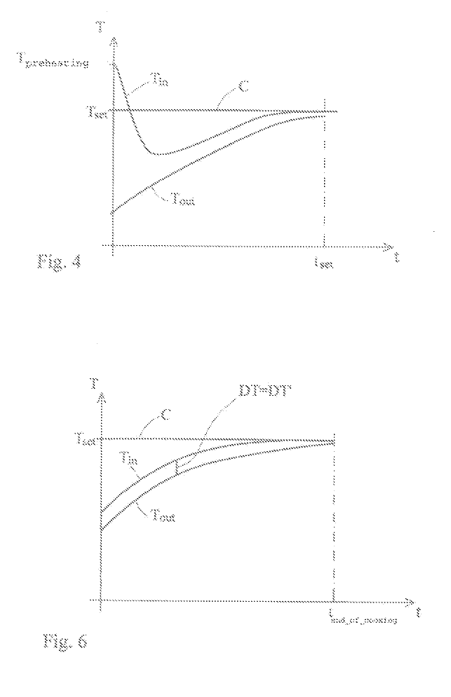

In a preferred example, provision is made to arrange the sensors 12 of the plurality of sensors in the intake area in alignment with each other and spaced apart along a vertical direction (which intersects the horizontal direction of the axis of rotation of the fan). This is because the aforesaid phenomenon is most strongly influenced in this vertical direction. FIG. 5 shows schematically the configuration described above, with the selection of four points of measurement of the temperature Tout.

To measure the temperature in the intake area of the fan 4, provision may also be made, as an alternative to the preceding example, for the use of a multipoint core sensor which is typically provided with a plurality of temperature measurement points. The multipoint core sensor may therefore be conveniently used for this type of cooking in which it is desirable to improve the uniformity of cooking by operating with small temperature differences DT.

FIG. 4 shows the trend of the temperatures Tin and Tout in the cooking chamber, without the use of the control method of the invention, assuming a uniform set point temperature (Tset) in the cooking time tset. In this example, pre-heating of the chamber is also provided, so that at the instant t=0 (start of cooking) the temperature Tin is greater than the temperature Tset. Clearly, the value of the difference DT is high in the initial stage of cooking, but is reduced progressively with the passage of time within the cooking time tset, becoming substantially equal to zero near the end of cooking.

On the other hand, FIG. 6 shows the trend of the temperatures Tin and Tout that may be obtained by using the method of the invention, in which the oven control tends to keep the temperature difference substantially constant and equal to the value DT′. As described above, using a difference DT which is advantageously reduced means that the cooking time (the interval between the instant tset and the actual instant of the end of cooking) must be increased.

Another advantage that may be obtained with this method is that it has an effect both on the energy used for cooking and on the cooking times, and also that pre-heating may be eliminated and cooking may be started even if the oven is at ambient temperature, or in any case is at a temperature of less than Tset. This is because, if the cooking is governed by the difference DT, the oven will start to cook at low values of the temperature Tin to keep DT at the predetermined value. The temperature Tin will then increase with the passage of time until it reaches the value of Tset at a time which may be either more or less than the time tset (FIG. 6). From that point onwards, Tin will be practically equal to Tset, and the value of DT will start to decrease until the desired degree of cooking is reached at the end of cooking time (t=tend_of_cooking) which is usually greater than tset. Thus the possibility of eliminating pre-heating results in both a reduction of the energy used for cooking and a saving of time.

Purely by way of example, to indicate an order of magnitude of the parameters present in the application of the method according to the invention, assuming that, for a given food, the corresponding cooking program provides for a temperature Tset of 180° C., and, assuming that the difference DT, calculated on the basis of the values Tin and Tout measured by the sensors, is equal to 20° C. at the start of the cooking process, it is likely that the value of the difference DT′ will be set, for example, at 10° C. The heating and fan means are therefore controlled by the oven control system with the aim of keeping the temperature difference in the cooking chamber equal to the value of the difference DT′ (for example by modulating the thermal power supplied by the oven). The difference DT in the cooking chamber is calculated on the basis of the temperature measurements made by the sensors 11, 12 with a certain measurement frequency, for example with measurements made every 0.5 second.

Any increase in cooking time (beyond tset), required because the oven is operating with a lower temperature difference DT and therefore with a lower average temperature of the air and/or steam, is then selected to complete the cooking process. This increase is then correlated with the set temperature difference DT′, and may vary according to the type of food being cooked. Usually, an increase in cooking time limited to not more than 100% of the cooking time tset is reasonably acceptable, given the improved uniformity of cooking achieved. Indeed, there are some industries, such as the bakery industry, where uniformity of cooking may be much more important than cooking time. The increase in cooking time may then be pre-selected on the basis of preferred values found experimentally and correlated both with the type of food and with the temperature differences used. In a first exemplary embodiment, the increase in cooking time may then be selected and set manually by the operator.

Alternatively, the increase in cooking time may be identified and set by an automatic system, being for example calculated by correction methods implemented in the control logic of the oven, for example of the type described in the co-pending Italian patent application no. 102015000015162 in the name of the present applicant, the description of which is considered to be entirely incorporated herein by reference within the limits of the purpose of the present invention.

Thus the invention achieves the proposed objects while achieving the stated advantages by comparison with the cited known solutions.

A principal advantage of the method according to the invention is that it improves and increases the uniformity of the cooking process (for a plurality of pieces of food contained in the same baking tray), by correcting the temperature profile in the cooking chamber and the actual cooking time for a pre-selected cooking program, on the basis of the difference between the temperatures measured by respective sensors at the entry to and the exit from the baking tray during the cooking process.

1. A method for controlling the cooking process in a cooking chamber of an oven for food use, the chamber being provided with at least one heating element, at least one fan having respective intake and delivery areas and at least one baking tray for containing food to be cooked, a temperature sensor is located in the delivery area of the at least one fan, configured to measure air temperature (Tin) and/or steam which comes into contact with the food at the entry to the at least one baking tray during the cooking process, by comparison with a cooking temperature (Tset) which is set in a corresponding cooking program and is variable in time, the cooking program providing a programmed cooking time (tset), wherein the method comprises the following steps:
providing at least a second temperature sensor in the intake area of the at least one fan, configured to measure a temperature (Tout) from the at least one baking tray at the entry to the fan during the cooking process,
calculating a temperature difference (DT) detected by the sensors, by subtracting the value of the intake temperature (Tout) from the temperature value (Tin) at the entry to the at least one baking tray,
setting a predetermined difference (DT′) between the aforesaid temperatures, this difference being less than the temperature difference (DT) calculated in the initial steps of the cooking process, such that it does not cause an increase in the programmed cooking time (tset) beyond a predetermined percentage of the cooking time, for the purpose of completing the cooking process,
controlling the at least one heating element and the at least one fan during the cooking process so as to keep the temperature difference (DT) in the cooking chamber equal to or below the predetermined value (DT') throughout the actual cooking time.

2. The method according to claim 1, wherein the predetermined temperature difference (DT′) is chosen to be in the range between DT−1° C. to DT=3° C. if DT−1° C.>1° C., or DT=2° C. for values of DT−1° C. less than or equal to 1° C., where DT is the value of the temperature difference calculated on the basis of the temperatures (Tin, Tout) measured by the respective temperature sensors in the cooking chamber.

3. The method according to claim 1, wherein the increase in the cooking time relative to the value specified in the predetermined program (tset) is chosen on the basis of the predetermined temperature difference (DT′), this increase not exceeding approximately 100% of the predetermined cooking time (tset).

4. The method according to claim 1, wherein a plurality of temperature sensors are provided in the intake area of the at least one fan, for measuring temperature (Tout) at separate points of the fan entry area during the cooking process, the lowest temperature of those measured being chosen for the calculation of the difference (DT) between the temperatures detected at the entry to the at least one baking tray and at the fan intake.

5. The method according to claim 4, wherein the said plurality of sensors are arranged, aligned and spaced apart from one another along an axial direction running vertically in the cooking chamber and intersecting an axis of rotation of the at least one fan, which is positioned horizontally.

6. The method according to claim 5, wherein the said plurality of sensors comprises a multipoint core sensor having a plurality of measurement points located in corresponding positions for measuring the temperature in the fan intake area.

7. An oven for food use comprising a cooking chamber provided with least one heating element, at least one fan having respective intake and delivery areas, at least one baking tray for containing food to be cooked, a temperature sensor in the delivery area of the at least one fan for measuring air and/or steam temperature (Tin) as the air and/or steam enters the at least one baking tray, at least a second temperature sensor in the intake area of the at least one fan for measuring temperature (Tout) at the exit from the at least one baking tray, corresponding to temperature at the entry to the fan during the cooking process, and an oven control unit for controlling the at least one heating element and the at least one fan, for carrying out the method of claim 1.
